(19) United States
(12) Patent Application Publication
(10) Pub. No.: US 2013/0113624 A1
(43) Pub. Date: May 9, 2013

(54) Multi-Tiered Predator Protection Device

(71) Applicant: Joseph Masciovecchio, South Windsor, CT (US)

(72) Inventor: Joseph Masciovecchio, South Windsor, CT (US)

(21) Appl. No.: 13/291,444

(22) Filed: Nov. 8, 2011

(51) Int. Cl. G08B 13/00

(52) U.S. Cl. 340/541

(57) ABSTRACT

A device for protecting property from predators without a physical barrier or obstacle to entry. The device includes a plurality of warning elements and at least one motion sensor. The sensor is configured to initiate a systematic escalating sequence of activation of warning elements responsive to detection of a predator within a predetermined range. A preferred embodiment has a first protection stage including activation of a first warning light element in a flash pattern, and activation of motion sensors. A second protection stage, including bright illumination by a second light element, is initiated by the motion sensors in response to detection of a predator. Motion sensors either initiate a third protection stage, including emission of a sound by a third warning sound element in response to continued detection of the predator or deactivates the second tier warning lights and returns the device to the first protection stage.

### BACKGROUND OF THE DISCLOSURE

The present disclosure relates to property protection devices, and more particularly, to a device configured to protect an area of property (including livestock, pets, individuals or the like thereon) from potential predators by emitting an escalating series of deterrents in response to detection.

### SUMMARY

Known protection products which create physical barriers around an area, such as fences or screens, are problematic because they create obstacles to access by authorized individuals as well as potential predators. Additionally, physical barriers are easily susceptible to circumvention by predators and breach of the area intended to be protected.

At least one product exists for protecting an area from predators without creating a physical barrier. The known product includes a constantly blinking light that is visible by potential predators facing the device, primarily in dark environmental conditions. Predators typically see the blinking light and may become threatened and frightened away from the area. The constant blinking light product also carries numerous significant drawbacks. For example, a predator can eventually become accustomed to the constant repeating flash pattern of the light and no longer be deterred from breaching the property. Additionally, known blinking light devices are only visible straight on, and thus at least four devices are needed to protect a 360° range of property.

There is a need for a multi-tiered protection device for providing a series of separate escalating deterrents in response to detected presence of a potential predator without a physical barrier or obstacle.

According to one embodiment of the disclosed device, a multi-tiered device for deterring advancement of a predator delivers an escalating succession of warning signals. The device has a motion detector connected to a housing. The motion detector is configured to detect motion or the presence of a predator within a predetermined distance thereof. A plurality of warning elements is integrated within the housing. The warning elements are configured to independently emit a warning from the housing when activated. At least one of the warning elements is communicatively connected to the motion detector and configured to emit a warning in response to a communication therefrom.

### BRIEF DESCRIPTION OF THE DRAWINGS

Aspects of the preferred embodiment will be described in reference to the Drawings, where like numerals reflect like elements:

FIG. 1 is an elevation view of a preferred embodiment of the disclosed multi-tiered protection device;

FIG. 2 is a rear view of the multi-tiered protection device of FIG. 1;

FIG. 3 is a side view of the multi-tiered protection device of FIG. 1;

FIG. 4 is bottom view of the multi-tiered protection device of FIG. 1;

FIG. 5 is an exploded view of the depicted multi-tiered protection device; and

FIG. 6 is a flow chart showing an embodiment of the tiered escalating activation sequence of the disclosed protection device.

### DETAILED DESCRIPTION OF THE PREFERRED EMBODIMENT

With reference to the drawings wherein like numerals represent like parts throughout the Figures, a multi-tiered predator protection 10 device is disclosed. Embodiments of the protection device allow users to protect an area of property, including without limitation livestock, pets, individuals and crops residing thereon, across a large area without requiring physical barriers or obstacles. The tiered and successive nature of activation of the independent warnings emitted from the device ensures that predators will not become accustomed to the warnings, and thus provides an efficient and very effective deterrent. Further, the device is configured to detect motion and emits signals visible over at least a 180° range, such that a maximum of only two device units is needed to cover a 360° range of property.

In a preferred embodiment, the warning device 10 has a housing body 12 with a front portion 12a and rear portion 12b. This embodiment has plurality of warning elements configured to be independently activated by a signal. The depicted device 10 features a three tier warning system with three separate warning elements. The warning elements in this embodiment comprise first tier warning lights 14, second tier warning lights 16 and third tier warning audio signal, which is emitted from the speaker unit 18. The warning device 10 also has at least one sensor 20. The sensors 20 are communicatively connected to at least one of the warning elements (14, 16 and/or 18) such that the connected warning element can be activated via a signal from the sensor 20 in response to the sensor detecting a condition such as motion. In this embodiment, the sensors 20 are connected to the second and third tier warning elements (16 and 18). The number, types and/or specific succession of warning initiation is not limiting.

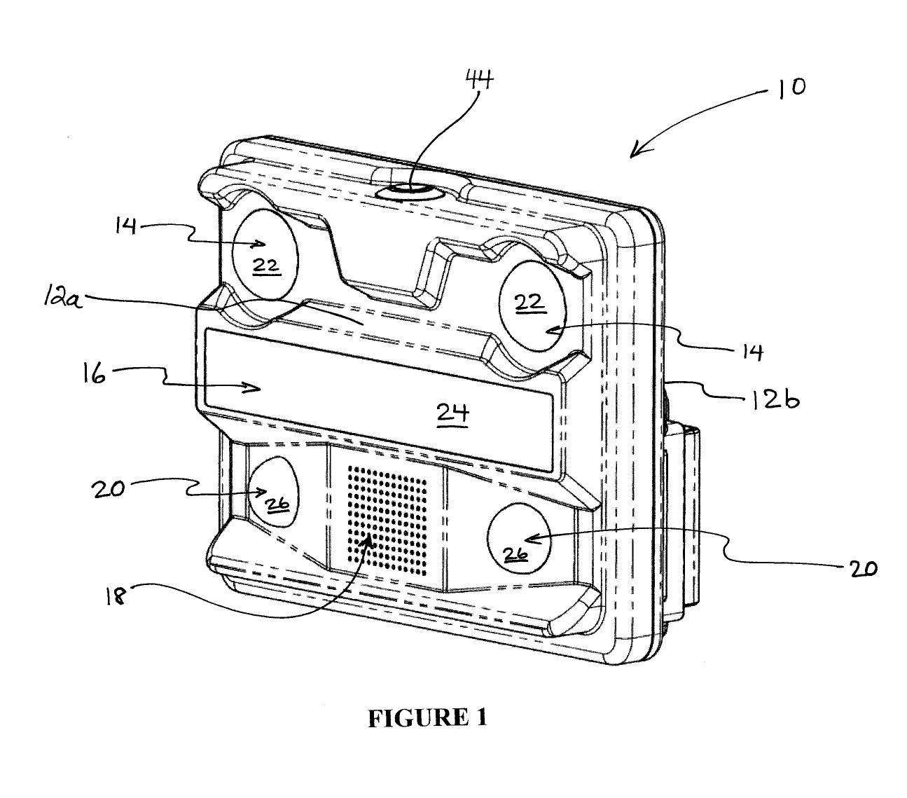

As can be seen in FIG. 1, the device preferably has two motion sensors 20 positioned in the housing front portion 12a. The sensors 20 are configured and positioned on or along the housing such that their collective radial range of detection is at least approximately 180°. In this embodiment, the front housing portion 12a has recessed/angled portions which aid in improving the radial range of the sensors 20. While the depicted embodiment includes two sensors 20 with generally semi-spherical lenses, the device is in no way limited in terms of size, shape or number of sensors.

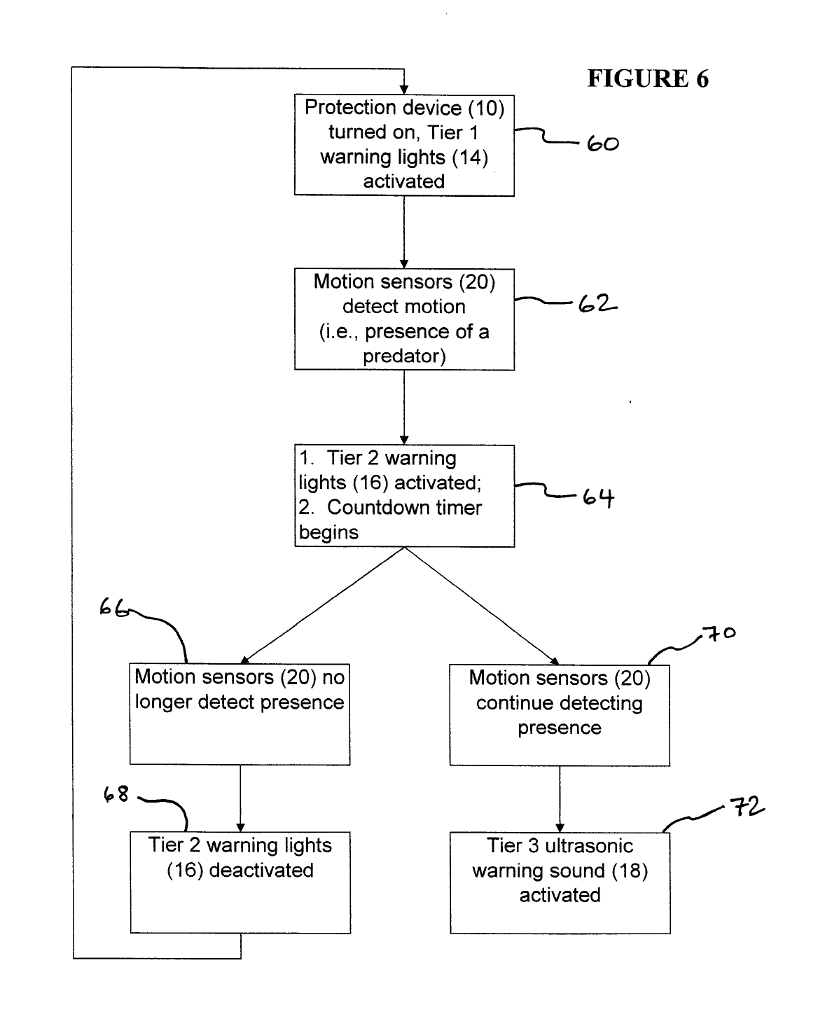

As can be seen, the warning lights 14 and 16 each comprise an inner light element and a lens substantially sealingly engaged within an aperture in the housing 12. LED light elements have been found to be particularly advantageous for use with the disclosed warning device due to a combination of low energy consumption, long life, high visibility and ability to emit a concise flash pattern. The type of light element can be varied as appropriate. The disclosed preferred embodiment employs red primary lenses 22 and a white elongate secondary lens 24, however the colors of the lenses can also be varied. As depicted in FIG. 6, the secondary light element 16 includes three LEDs fixed on a single panel. The panel is positioned so that the LEDs extend into the inner arch portion of the elongate reflector 26.

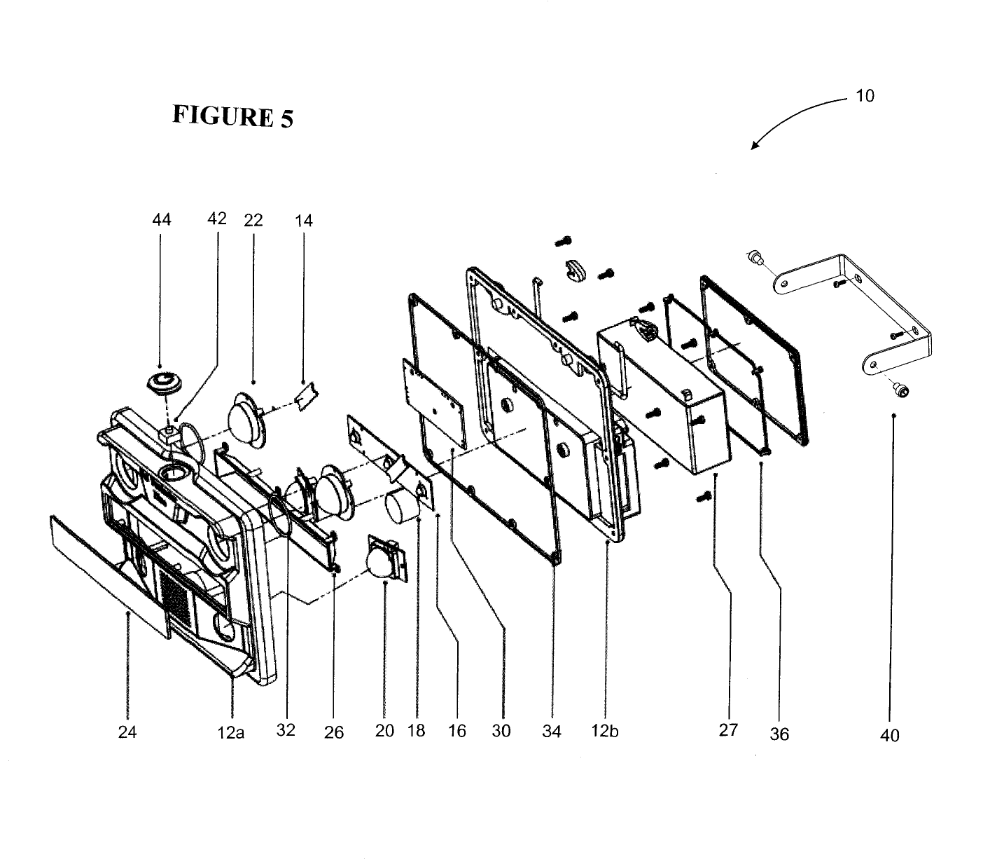

As indicated in FIG. 5, the warning device 10 has an internal battery 27, which is electrically connected to each of the warning elements 14, 16 and 18, and sensors 20. The battery 27 draws and stores power from a connected source of electricity through power inlet 46. A solar (i.e., photovoltaic) panel, such as that depicted schematically in FIG. 3 as reference numeral 28, can advantageously be used to supply an electrical charge to the battery 27. The panel 28 can be strategically positioned in a location that receives substantial sunlight. Alternatively, the warning device can be equipped with a solar panel which is fixed in a position on an outer portion of the housing 12, such as the top surface.

To improve durability of the protection device 10, the internal components of the device 10 are substantially sealed from the environment exterior to the housing 12. As shown most clearly in FIG. 5, liquid impermeable seals such as o-rings 32 and gaskets 34 and 36, or like elements can be positioned between adjoining elements of the device 10. Additionally, a malleable liquid impermeable seal cap 44 is disposed over the power switch 42. The O-rings, gaskets and seal cap assist in protecting the internal components from damage from liquid and extreme temperatures.

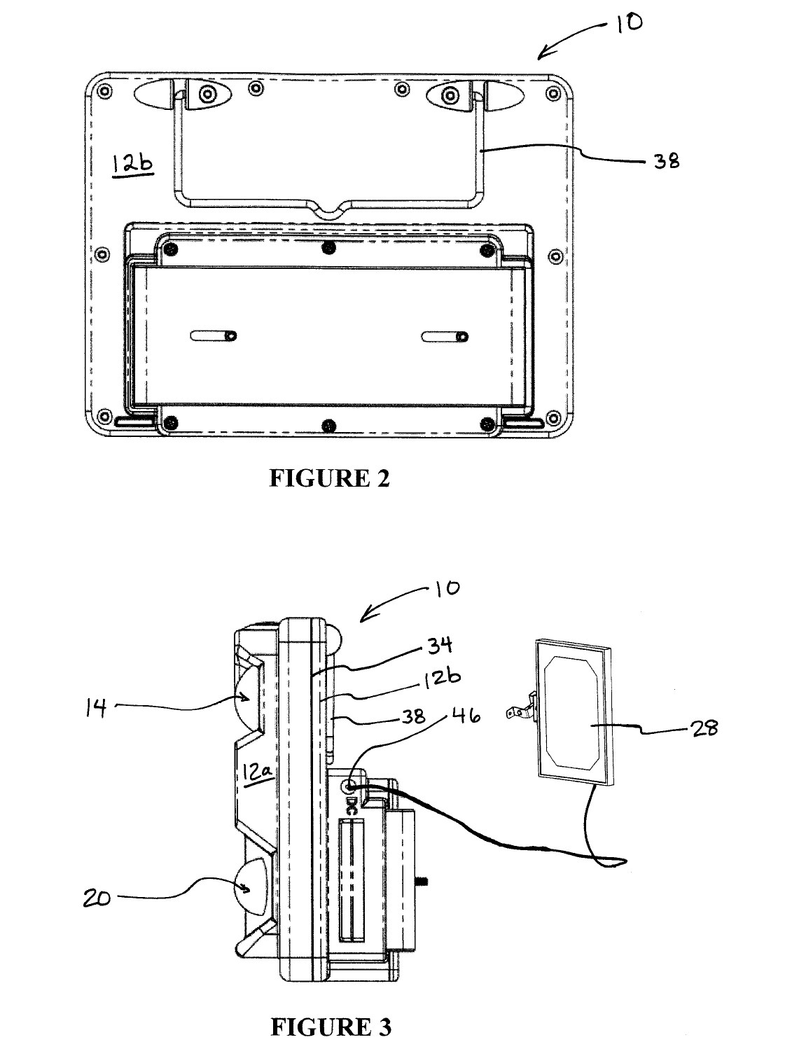

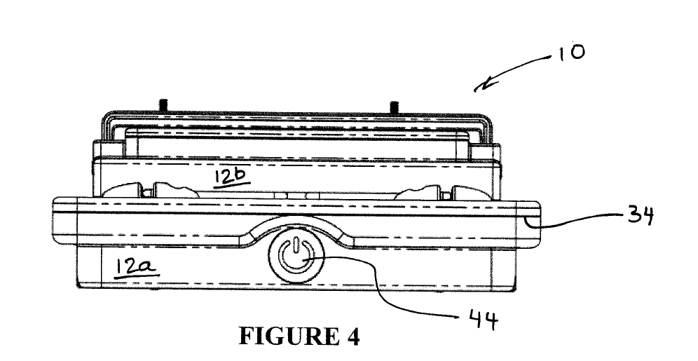

The warning device 10 is configured to be removably attachable to an object or surface, such as for example, a tree, deck, fence or wall. Referring to FIG. 2, the device can be optionally fit with a hanging element, such as the pivotable handle 38, for easy transportation or even to assist in attaching to a surface. As shown in FIG. 5, this embodiment also includes a pivotable holder 40, which is independently attachable to a surface and the housing 12. Here, the holder 40 can be fixed to an object such as a tree or fence post with the depicted screws and the device 10 can be attached thereto, optionally in a removable engagement. Notably, the holder 40 can be fixed to an object or surface and the protection device 10 can be pivoted thereabout to allow the front portion 12a to be positioned to target a variety of predators. For example, the protection device 10 can be pivoted upward relative to the surface and holder 40 to target airborne predators such as hawks or owls. Other known methods of attachment of the holder 40 to an object can be employed, such as hook-and-loop fasteners, screws, nails, adhesive, or the like. Additionally, the depicted attachment between the housing 12 and holder 40 is not limiting.

With further reference to FIG. 5, the automated operation of the protection device 10, including initiation of warning signal activation, is controlled by the PCB board 30. Here, the first tier warning light elements 14 each also includes a separate PCB element for controlling the flash pattern of light emission, when activated. Each of the additional warning elements can optionally include a separate PCB element for controlling specific behaviors of the individual warning element. For example, an associated PCB element can be configured to control flash patterns and emission intensity of a light element. The emission pattern, intensity and frequency of an individual warning sound can be similarly controlled.

As noted, the protection device 10 is configured to provide an escalating (tiered) sequence of independently-activated deterrents in response to detection of a potential predator. FIG. 6 shows the typical operation of a preferred embodiment of the protection device 10. The device 10 is first positioned in a strategic and visible location on a property in need of protection from predators. The device 10 is then powered on by the power switch 42 at a time when protection is needed or desired. Turning on the device activates the first tier warning lights 14 in the first protection stage 60. Preferably, when activated, the first tier warning lights 14 emit visible light in a predetermined flash pattern. Alternatively, the first tier warning lights 14 can remain illuminated with a continuous emission of visible light. The preferred embodiment employs red colored lenses 22 configured to generally mimic the appearance of another animal's eyes in dark environments, and thus deter entry onto the protected property by a potential predator.

Powering on the device 10 also activates the motion sensors 20. The sensors 20 can be any type suitable for detecting motion or new presence of an object or individual, including passive infrared, ultrasonic, microwave and/or topographic detector sensors. The sensors 20 are configured with a collective radial range of approximately 180° and a radius of detection of approximately 30 feet. In this embodiment, the sensors 20 are electrically connected to the second tier warning light element 16 and third tier warning sound element 18. When motion is detected within the range (reference numeral 62), the sensors 20 send an electrical signal to activate the second tier warning lights 16 in the second protection stage 64. In this embodiment, the second tier warning lights 16 are positioned within an elongate reflector 26 behind a generally colorless lens 24. The second tier warning lights 16 deliver bright white illumination over a substantial area of the property which further deters encroachment by the potential predator.

At the second protection stage 64, an electrical countdown timer is triggered substantially simultaneously to the second tier warning lights 16. If the predator flees the area and is no longer detected by the sensors 20 within a predetermined period of time, the second tier warning lights 16 are deactivated (see reference numeral 68) and the protection cycle returns to the first protection stage 60.

Alternatively, if the sensors 20 continue to detect presence of the predator at the predetermined point in time (reference numeral 70), the third tier warning sound element 18 is activated, thus initiating the third protection stage 72. In one preferred embodiment, the sound element 18 is configured to emit a very loud siren-like sound. Alternative embodiments exist that emit different types of sounds, such as for example, an ultrasonic sound that is disturbing to animals (potential predators), while being essentially inaudible to humans. The sound element 18 can continue to emit the sound until the sensors 20 no longer detect the presence of the predator within the predetermined range. Once the predator flees the range of detection, the sensors 20 send signals to deactivate the second tier warning light element 16 and third tier warning sound element 18, returning the device 10 to the first tier protection stage 60. Alternatively, the device 10 can be configured for the sound element 18 to emit the sound for a predetermined specific duration or for a predetermined duration after the predator leaves the detection range.

Another embodiment of the device 10 employs a light sensor, rather than a manual switch, for controlling activation of the first tier warning lights 14 and motion sensors 20. In this embodiment, the light sensor constantly detects the presence or absence of light, such as sunlight. Once light detection by the light sensor reaches a threshold level (i.e., when the sun goes down in the evening), the sensor initiates the first tier protection stage 60 by sending a signal to activate the first tier warning lights 14 and motion sensors 20. The cycle of delivering systematic escalating deterrents and protection levels operates as described above.

### Experimental

The disclosed multi-tiered protection device 10 has been shown to significantly deter encroachment onto a property by predators in an efficient manner. The test property was an approximately 10 acre property having a chicken coop surrounded by forest land. On the first night, a prior art device featuring a constantly blinking warning light was installed near the coop filled with live chickens (potential prey). The next day, it was found that three chickens were missing from the coop (i.e., taken by a predator). The same prior art device was deployed in the same location on the second night. The following day, it was found that two more chickens had been taken by a predator.

On the third night, multi-tiered protection device 10 was deployed in the same location that the prior art device was deployed on the first and second nights. The device 10 utilized in the experimental was a three-tiered with a first tier warning light element 14, second tier warning light element 16 and third tier warning sound element 18. The warning sound element 18 of the experimental device emitted a loud audible sound when activated. The multi-tiered protection device 10 employed a light sensor for activating and deactivating the first tier protection stage 60, such that the first tier protection stage was activated at dusk and deactivated at dawn. The third tier warning sound element 18 was observed to have been activated at least once on the third night. It was found that zero chickens were taken on the third night.

The multi-tiered protection device 10 has been deployed every night for four weeks (test period). The second tier warning light element 16 and third tier sound element 18 have been observed numerous times during the test period without observation of further predator activity in the subject chicken coop. Additionally, properties surrounding the test property that have not installed a multi-tiered protection device 10 have observed significant predator activity during the test period. Consequently, it can be concluded that the multi-tiered protection device 10 is exceedingly effective at deterring predator advancement on a property.

Clearly, additional embodiments of the disclosed multi-tiered protection device can exist having various combinations of warning element types, number of warning elements, activation sequence, flash or emission patterns and/or intensities. The disclosed embodiments utilize a three-stage protection cycle including a successive initiation of a first warning light element 14, followed by second warning light element 16, and finally third warning sound 18, which has been found to be particularly effective at deterring encroachment of a property. However, embodiments are not limited in terms of number or succession patterns of warning signals.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

1. A multi-tiered device for deterring advancement of a potential predator by delivering an escalating succession of warning signals, comprising:
(a) a housing unit;
(b) a motion detector connected to the housing unit for detecting motion or presence of a predator within a predetermined distance of the housing unit;
(c) a plurality of warning elements integrated within the housing unit, each of said warning elements being configured to independently emit a warning outward from the housing when activated, wherein
at least one of the plurality of warning elements is in communication with and configured to emit a warning in response to a communication from the motion detector.

2. The multi-tiered device of claim 1, comprising a light sensor in communication with at least a first warning element and the motion detector for detecting the intensity of light in the environment surrounding the housing, wherein the light sensor initiates activation of at least said first warning element and said motion detector in response to the intensity of environmental light reaching a predetermined level.

3. The multi-tiered device of claim 1, wherein a second warning element is independently activated after activation of a first warning element, activation of the second warning element being initiated by communication from the motion detector in response to detection of a potential predator within a predetermined distance of said housing.

4. The multi-tiered device of claim 3, comprising at least three warning elements, wherein activation of a second warning element is initiated at a first point in time by communication from the motion detector in response to detection of a potential predator within a predetermined distance of said housing, and activation of a third warning element is initiated at a later second point in time by communication from the motion detector in response to continued detection of said potential predator for a predetermined duration from said first point in time.

5. The multi-tiered device of claim 1, wherein said plurality of warning elements are individually chosen from a list consisting of warning lights, warning sounds and combinations thereof.

6. The multi-tiered device of claim 5, comprising at least one warning light and at least one warning sound, wherein said at least one warning light is a light-emitting diode (LED) and the at least one warning sound is has a frequency within a range that is audible to humans ultra sonic range.

7. The multi-tiered device of claim 6, comprising at least one warning light, wherein said at least one warning light has a lens configured to emit a signal along a radius of substantially 180°.

8. The multi-tiered device of claim 5, comprising at least a first, second and third warning element, wherein a first warning element comprises a warning light, and the second and third warning elements independently comprise a warning light and a warning sound.

9. The multi-tiered device of claim 1, comprising at least three warning elements configured to be activated in succession, wherein
the first warning element and the at least one motion sensor are activated at a first point in time;
the second warning element is activated independent of the first warning element at a second point in time by a signal from the motion detector in response to detection of motion of a potential predator within a predetermined distance; and
a third warning element is activated independent of the first and second warning elements at a third point in time by a signal from the motion detector in response to continued detection of the presence of the potential predator within a predetermined distance at a predetermined duration from the second point in time.

10. The multi-tiered device of claim 9, wherein the first and second warning elements are each light-emitting elements and the third warning element is a sound-emitting element.

11. The multi-tiered device of claim 1, wherein the at least one motion sensor is configured to detect motion within a range of at least approximately 30 feet.

12. The multi-tiered device of claim 4, wherein the first warning element comprises at least one LED configured to emit a predetermined pattern of light signals when activated, the second warning element comprises at least one LED configured to deliver a constant emission when activated, and the third warning element is a sound unit configured to emit an audible sound.

13. The multi-tiered device of claim 1, comprising a solar panel electrically connected to a battery, wherein the battery is electrically connected to each of the warning elements and the sensors, the solar panel being configured for generating and delivering electricity to the battery.

14. The multi-tiered device of claim 1, comprising a holder attached to and pivotable relative to the housing.

15. The multi-tiered device of claim 5, comprising at least one warning light and at least one warning sound, wherein said at least one warning light is a light-emitting diode (LED) and the at least one warning sound is has a frequency in the ultra sonic range.

16. The multi-tiered device of claim 4, wherein the first warning element comprises at least one LED configured to emit a predetermined pattern of light signals when activated, the second warning element comprises at least one LED configured to deliver a constant emission when activated, and the third warning element is a sound unit configured to emit an ultrasonic sound.

17. A multi-tiered device for deterring advancement of a potential predator by delivering an escalating succession of warning signals, comprising:
a motion detector;
a first warning element configured to release a pattern of light emission;
a second warning element communicatively connected to the motion detector; and
a third warning element communicatively connected to the motion detector, wherein the first warning element and motion detector are each activated prior to a second time T₂, the second warning element is activated by a signal from the motion detector at the second time T₂, and the third warning element is activated by a signal from the motion detector at a third time T₃ which is after T₂, activation of the second warning element being initiated in response to detection of a predator by the sensor and activation of the third warning element being initiated in response to continued detection of the predator.

18. The multi-tiered device of claim 17, wherein the first, second and third warning elements are each independently chosen from a list consisting of warning lights and warning sounds.

19. The multi-tiered device of claim 18, wherein the first and second warning elements comprise warning lights and the third warning element comprises a warning sound.
